(19) United States
(12) Patent Application Publication
(10) Pub. No.: US 2009/0235286 A1
(43) Pub. Date: Sep. 17, 2009

(54) Software radio device

(75) Inventors: Yusuke Kanahashi, Hamura-shi (JP); Michitomo Suzuki, Hamura-shi (JP)

Correspondence Address: OLIFF & BERRIDGE, PLC, P.O. BOX 320850, ALEXANDRIA, VA, 22320-4850, US

(73) Assignee: HITACHI KOKUSAI ELECTRIC INC., Tokyo (JP)

(21) Appl. No.: 12/382,052

(22) Filed: Mar. 6, 2009

(30) Foreign Application Priority Data
Mar. 11, 2008 (JP) 2008-061432

(51) Int. Cl. G06F 9/44

(52) U.S. Cl. 719/328

(57) ABSTRACT

A software radio device according to the present invention has plural executing devices constituting the software radio device as a whole, each of the executing devices executing application software by a board computer. In the software radio device, first application software executed by at least one first executing device of the plural executing devices makes the first executing device execute an instructing step of instructing the executing device to execute a determination step, and upon reception of the instruction, second application software other than the first application software executed in the executing device makes the executing device execute the steps of determining, on the basis of an operation environment of predetermined application software and environmental information of the board computer whether the predetermined application software is executable in the executing device, and loading into the executing device the application software which is determined to be executable.

### BACKGROUND OF THE INVENTION

1. Field of the Invention

The present invention relates to a software radio device and computer system comprising plural executing devices that execute application software.

2. Description of the Related Art

For example, JP-A-2006-65776 discloses a software radio device having middleware mounted therein.

### SUMMARY OF THE INVENTION

The present invention has been implemented from the foregoing situation, and has an object to provide a software radio device and computer system that are improved so that a device and a platform which can execute application software can be automatically identified when devices and platforms are added.

In order to attain the above object, a software radio device according to the present invention has plural executing devices constituting the software radio device as a whole, each of the executing devices executing application software by a board computer. In the software radio device, first application software executed by at least one first executing device of the plural executing devices makes the first executing device execute an instructing step of instructing the executing device to execute a determination step, and upon reception of the instruction, second application software other than the first application software executed in the executing device makes the executing device execute the steps of determining, on the basis of an operation environment of predetermined application software and environmental information of the board computer whether the predetermined application software is executable in the executing device, and loading into the executing device the application software which is determined to be executable.

According to a software radio device and computer system of the present invention, when the device and the platform are added, the device and the platform which can execute application software can be automatically identified.

### BRIEF DESCRIPTION OF THE DRAWINGS

FIGS. 1A to 1C are diagrams showing the relationship between a device, a platform and a resource software, wherein FIG. 1A shows an operation that arranged resource software is rearranged in another device or platform, FIG. 1B shows resource software which is fixedly arranged in predetermined device and platform, and FIG. 1C shows an operation that resource software is automatically arranged in an executable device and a platform;

FIG. 2A is a diagram showing an example of the construction of a radio device according to the present invention, and FIG. 2B is a diagram showing an example of the construction of each board computer shown in FIGS. 1A to 1C;

FIG. 3A is a diagram showing the construction of resource management software executed in the board computer shown in FIG. 2(B), and the construction of resource arrangement software executed in each of the board computers, and FIG. 3B is a diagram showing a profile stored by a profile storage part of the resource management software shown in FIG. 3A;

FIG. 4A is a diagram showing an example of environment information of each board computer, and FIG. 4B is a diagram showing method allocationJudge;

FIG. 5 is a flowchart showing the processing (S10) of the resource management software and the resource arrangement software;

FIG. 6 is a flowchart showing the processing (the processing of method allocationJudge) (S20) of a determining part shown in FIG. 5; and

FIG. 7 is a communication sequence diagram (S50) showing an example of the overall operation of the resource arrangement system.

### DETAILED DESCRIPTION OF THE PREFERRED EMBODIMENTS

[Background of the Invention]

In order to assist the understanding of the present invention, the background of the invention will be first described.

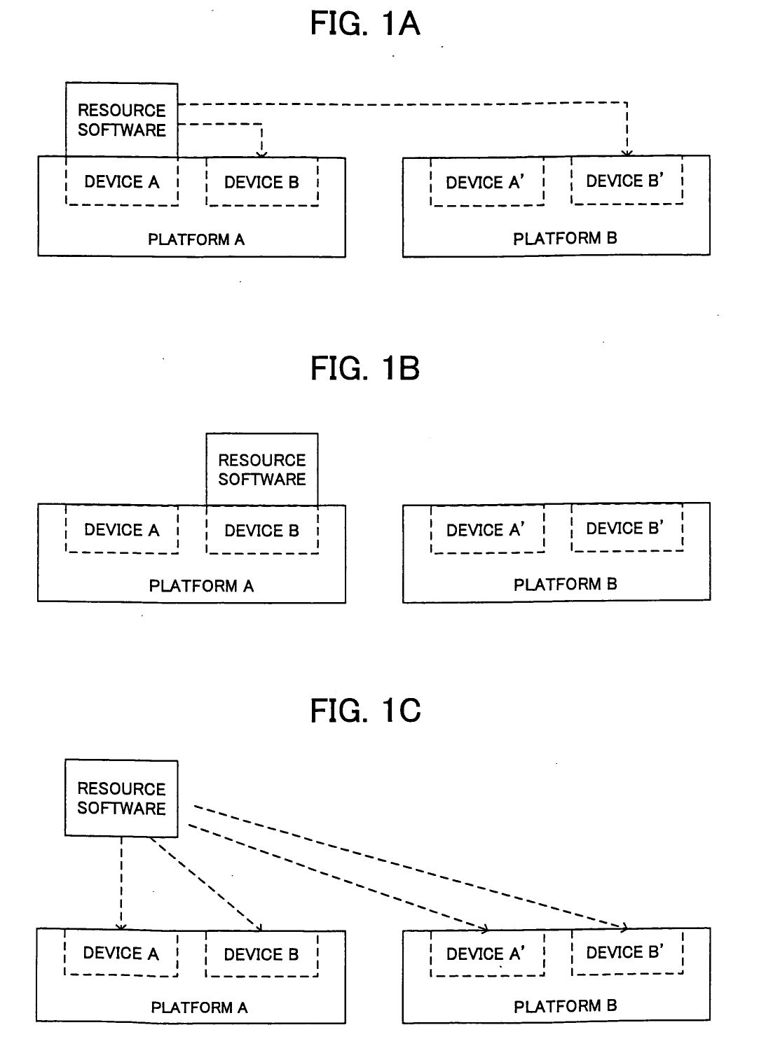

FIGS. 1A to 1C are diagrams showing the relationship of a device, a platform and resource software, wherein FIG. 1A shows an operation that arranged resource software is rearranged in another device or platform, FIG. 1B shows resource software which is fixedly arranged in predetermined device and platform, and FIG. 1C shows an operation that resource software is automatically arranged in an executable device and a platform.

Application software can operate or cannot operate in accordance with types of a device and a platform. For example, there is a case that application software operating on Linux(registered trademark) OS does not operate on Windows(registered trademark) OS. For example, after application software is arranged in a platform in no consideration of the type thereof, it is determined whether the application software concerned can be executed or not.

When it is determined that it is impossible to execute the arranged application software, this application software must be re-arranged in another platform or device which is suitable for this operation.

The application software as an arrangement target will be hereinafter referred to as “resource software”.

However, as shown in FIG. 1A, it is technically difficult that resource software which is once arranged in a predetermined device is automatically rearranged in another platform or device, and thus this rearrangement is not normally performed.

Accordingly, when a user wants to arrange resource software, the user must know executable platforms and devices in advance, and he/she must arrange the resource software in the executable platforms and devices. That is, as shown in FIG. 1B, the resource software is fixedly arranged in pre-indicate platform and device.

The present invention has been implemented from the foregoing background, and an improvement is made so that before predetermined resource software is arranged as shown in FIG. 1C, a board computer having a platform and a device which can execute the resource software is automatically identified, and the resource software is automatically arranged in the board computer which is identified as an executable computer.

That is, the user can arrange predetermined resource software without regard to the platforms, devices and the like.

[CORBA]

In order to assist the understanding of the present invention, software distributed processing based on CORBA will be described.

CORBA (Common Object Request Broker Architecture) is middleware that supports the communication between objects in a distributed environment on a network.

Specifically, exchange of messages between objects (program goods) created by using hardware, OS (Operating Systems), programming languages which are different from one another is performed by a proxy (deputy) object called as stab, skeleton on a software bus called as ORB (Object Request Broker).

Accordingly, the user can architect applications without paying attention to the types of hardware, OS and programming languages by CORBA.

[Radio Device 1]

A radio device 1 according to the present invention will be described hereunder.

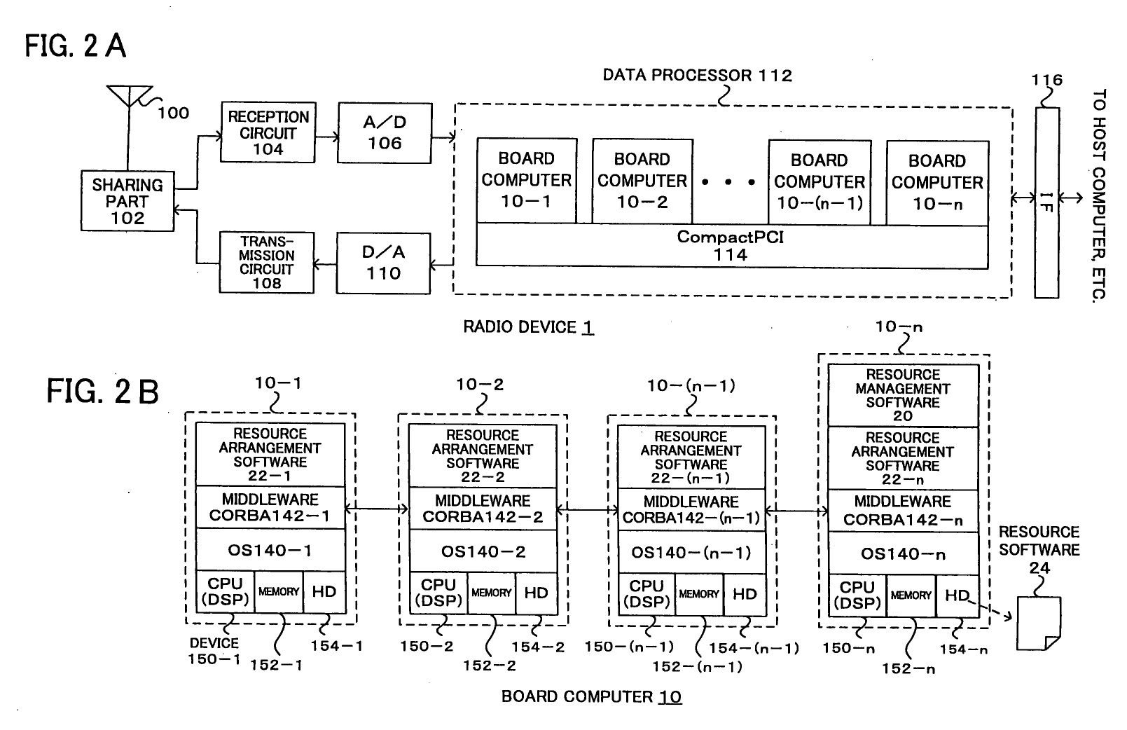

FIG. 2A is a diagram showing an example of the construction of the radio device 1 according to the present invention.

As shown in FIG. 2A, the radio device 1 comprises an antenna 100, a sharing part 102, a reception circuit 104, an analog/digital converter (A/D) 106, a transmission circuit 108, a digital/analog converter (D/A) 110, a data processor 112 and an interface circuit (IF) 116.

The data processor 112 comprises plural board computers 10-1 to 10-n which are connected to one another through a bus such as Compact PCI (Peripheral Component Interconnect) 114, etc.

Here, n represents an integer above 1, and all n are not necessarily equal to the same number.

When any one of plural constituent parts such as the board computers 10-1 to 10-n, etc. is represented, it may be merely represented as “device 10” in some cases.

Substantially the same constituent parts and processing are represented by the same reference numerals.

The antenna 100 transmits/receives transmission signals to/from another radio device (not shown) through a radio communication line or the like (not shown).

The sharing part 102 makes the reception circuit 104 and the transmission circuit 108 share the antenna 100. The reception circuit 104 performs processes of down-convert and amplification and like for a reception signal which is input from the antenna 100 through the sharing part 102, converts the processed signal to a reception signal of a base band and then outputs the converted reception signal to A/D 106.

A/D 106 converts the analog type base band reception signal input from the reception circuit 104 to a digital type reception signal, and outputs the digital reception signal to a data processor 112.

D/A 110 converts the digital type base band transmission signal input from the data processor 112 to an analog type transmission signal (transmission signal) and outputs the analog type transmission signal to the transmission circuit 108.

The transmission circuit 108 performs processes of up-convert and amplification and like for base band transmission signal and then radio transmits the processed transmission signal through the sharing part 102 and the antenna 100.

As described above, the data processor 112 comprises plural board computers 10 which are connected to one another through a bus such as Compact PCI 114 or the like.

Each of the board computers 10-1 to 10-n executes software (program), and executes processing such as demodulation of the reception signal, the modulation of the transmission signal, etc. in a distribution (dispersion) style.

IF 116 executes the processing of transmitting/receiving data to/from a host computer or the like (not shown) which is connected to the radio device 1.

[Board Computer 10]

FIG. 2B is a diagram showing an example of the construction of the board computer 10 shown in FIG. 1.

The board computer 10-i (1≦i≦n) contains a device 150-i such as CPU, DPS or the like, a memory 152-i and a hard disk (HD) 154-i such as a magnetic disk or the like.

The devices 150-1 to 150-n maybe the same type of devices or different types of devices.

Furthermore, the memories 152-1 to 152-n may be the same type of memories or different types of memories.

Furthermore, OS 140-i is installed in the board computer 10-i. OS 140-1 to 140-n may be the same type OS or different types of OS.

CORBA 142-i as middleware operates on OS 140-i, and the resource arrangement software 22-i operates ion CORBA 142-i.

Furthermore, the resource management software 20 operates on any one or more CORBA 142 of the board computers 10-1 to 10-n.

The resource software 24 is stored in any one or more HD 154 of the board computers 10-1 to 10-n.

In order to clarify and embody the description, the resource management software 20 operates on the CORBA 142-n of the board computer 10-n, and the resource software 24 is stored in HD 154-n.

[Software Construction]

The resource management software 20 and the resource arrangement software 22 shown in FIG. 2B will be described hereunder.

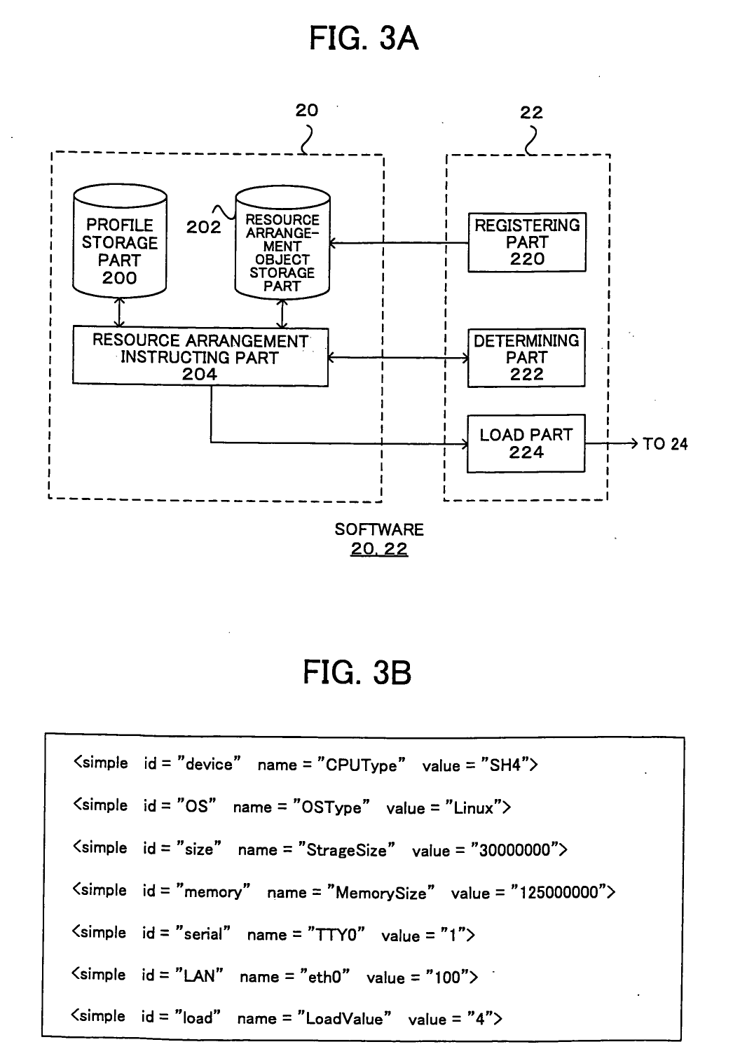

FIG. 3A is a diagram showing the construction of the resource management software 20 executed in the board computer 10-n shown in FIG. 2B and the construction of the resource arrangement software 22 executed in each of the board computers 10-1 to 10-n, and FIG. 3B is a diagram showing a profile stored by a profile storage part 200 of the resource management software 20 shown in FIG. 3A.

As shown in FIG. 3A, the resource management software 20 contains the profile storage part 200, a resource arrangement object storage part 202 and a resource arrangement instructing part 204.

The resource arrangement software 22 contains a registering part 220, a determining part 222 and a load part 224.

The resource management software 20 and the resource arrangement software 22 are stored in a memory 152, for example, and it is supplied to the board computer 10 and executed on OS 140 of the board computer by specifically utilizing the hardware resource of the board computer 10.

By the above construction, the resource management software 20 and the resource arrangement software 22 identify the board computer 10 in which the resource software 24 can be arranged, and load the resource software 24 to the board computer 10.

[Resource Management Software 20]

The profile storage part 200 (FIG. 3A) stores the profile shown in FIG. 3B, and outputs the profile to the resource arrangement instructing part 204.

The profile stored by the profile storage part 200 will be described hereunder.

The profile stored by the profile storage part 200 is a file describing the types of a device, OS, etc. in which the resource software 24 can operate.

For example, there is a case where the resource software 24 cannot operate in accordance with the type of a device 150, OS 140 or the like of the board computer 10.

Specifically, in some cases the resource software 24 operates on Linux OS, however, it does not operate on Windows OS.

That is, when the board computer 10 does not have any environment such as a device 150 and OS 140 in which the resource software 24 can operate, it cannot execute the resource software 24 even when the resource software 24 is arranged in the board computer 10.

Accordingly, the types of the device, OS, etc. on which the resource software 24 as an arrangement target can operate are described in the profile.

As shown in FIG. 3B, the profile is described in the XML formats.

In the example of the profile shown in FIG. 3B, the environment in which the resource software 24 can operate is set as follows.

(1) Device Type (Type such as CPU, DSP or the like): SH4

(2) Type of OS: Linux

(3) Required Storage Size: 30 MB

(4) Required Memory Size: 125 MB

(5) Required Number of Serial Ports: one

(6) Required Speed of LAN interface: 100 MB

(7) Load of System: 4

The resource arrangement object storage part 202 (FIG. 3A) stores information of the resource arrangement software 22 received from the registering part 220 of the resource arrangement software 22, and outputs it to the resource arrangement instructing part 204.

The resource arrangement instructing part 204 makes the determining part 222 of the resource arrangement software 22 registered in the resource arrangement object storage part 202 successively execute the determining operation.

Furthermore, the resource arrangement instructing part 204 outputs the profile input from the profile storage part 200 to the determining part 222 to execute.

Furthermore, the resource arrangement instructing part 204 receives a judgment result (arrangement possible/arrangement impossible) of the determining part 222 from the determining part 222.

When receiving the arrangement-possible result from the determining part 222, the resource arrangement instructing part 204 receives an object reference of a load part 224 and makes the load part 224 execute the loading operation.

[Resource Arrangement Software 22]

The registering part 220 (FIG. 3A) registers the information of the self resource arrangement software 22 into the resource arrangement object storage part 202 of the resource management software 20.

The registering part 220 executes the above registration processing when the board computer 10 is connected to Compact PCI 114, for example.

According to an instruction of the resource arrangement instructing part 204, the determining part 222 determines whether the board computer 10 has an environment such as a device 150, OS 140 or the like in which the resource software 24 can be executed (arrangement possible or arrangement impossible).

That is, each of the determining parts 222 executed in the board computers 10-1 to 10-n respectively has environment information of the self board computer 10, and determines on the basis of the environment information concerned whether the resource software 24 can be arranged or not.

The environment information will be further described.

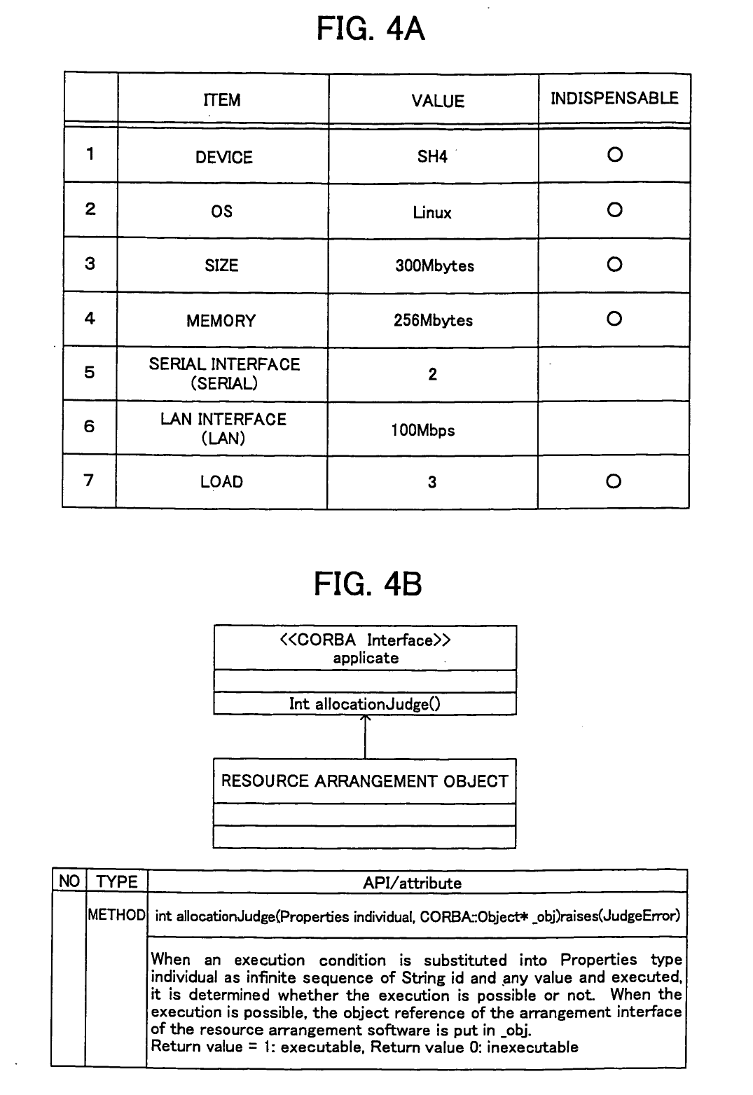

FIG. 4A is a diagram showing an example of the environment information of each board computer 10.

As shown in FIG. 4A, the determining part 222 has environment information of the board computer 10 containing the following items.

(1) Device Type

(2) OS Type

(3) Storage Size

(4) Memory Size

(5) Number of Serial Ports

(6) Speed of LAN interface

(7) Average Load of System

These environments are different every board computer 10.

FIG. 4A shows an example in which (1) the device type is [SH4], and (2) the OS type is {Linux] or the like.

The determining part 222 determines whether the environment of the board computer 10 exemplified in the conditions (1) to (7) satisfies the environment necessary for executing the resource software 24.

Here, As shown in FIG. 4A, (1) to (4) and (7) are items which must be certainly satisfied (indispensable items), and (5) and (6) may be set as items to be recommended (items which are not indispensable) or the like.

Specifically, the determining part 222 executes the method allocationJudge to determine whether the resource software 24 should be arranged or not.

The method allocationJudge will be described hereunder.

{Method AllocationJudge]

FIG. 4B is a diagram showing the method allocationJudge.

As shown in FIG. 4B, the method allocationJudge reads a profile described in the XML format shown in FIG. 3B, substitutes a value into Properties type individual as an infinite sequence of String type id and any type value and determines whether the resource software 24 should be arranged or not.

That is, id and value of the profile described in the XML format shown in FIG. 3B are delivered as arguments of the method allocationJudge.

When determining that the resource software 24 can be arranged (i.e., executable), the method allocationJudge sets the object reference of the load part 224 of the resource arrangement software 22 in the object reference “_obj”, and further returns a return value “1”.

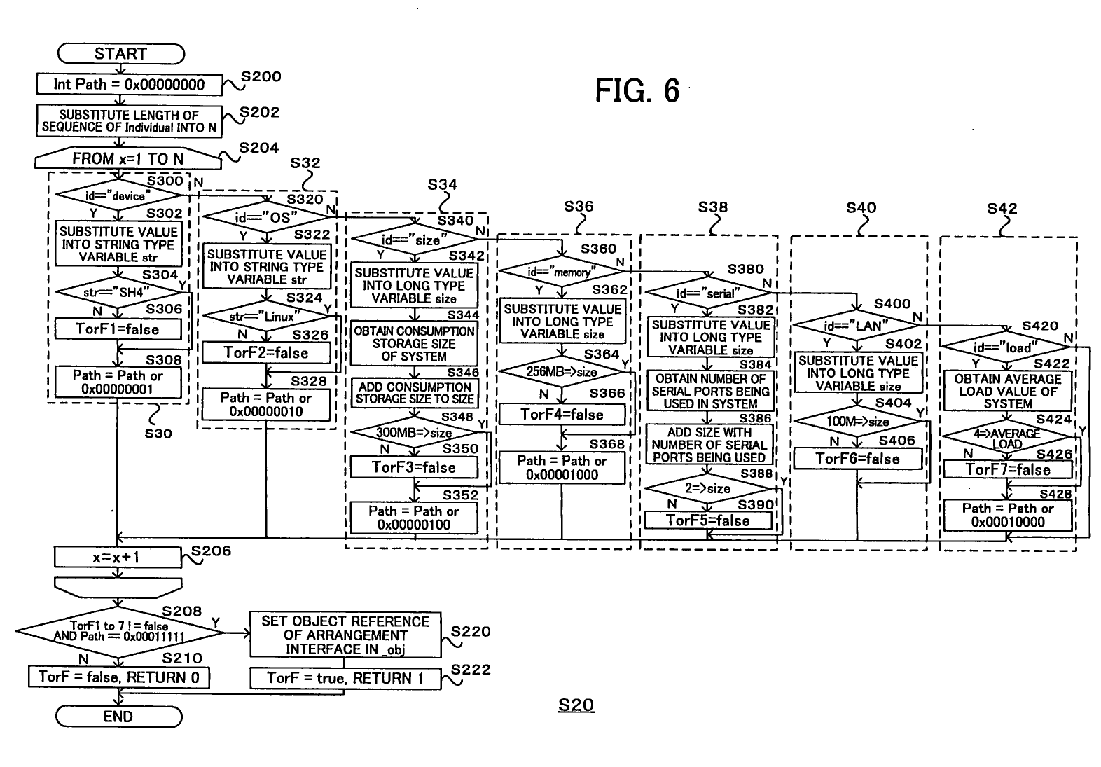

Furthermore, when determining that the resource software 24 cannot be arranged (i.e., inexecutable), the method allocationJudge returns a return value “0” (the processing flow of the method allocationJudge will be described later with reference to FIG. 6).

According to an instruction of the resource arrangement instructing part 204, the load part 224 (FIG. 3A) loads the resource software 24 into the memory 152 to execute the resource software 24. [Operation of Resource Management Software 20/Resource Arrangement Software 22].

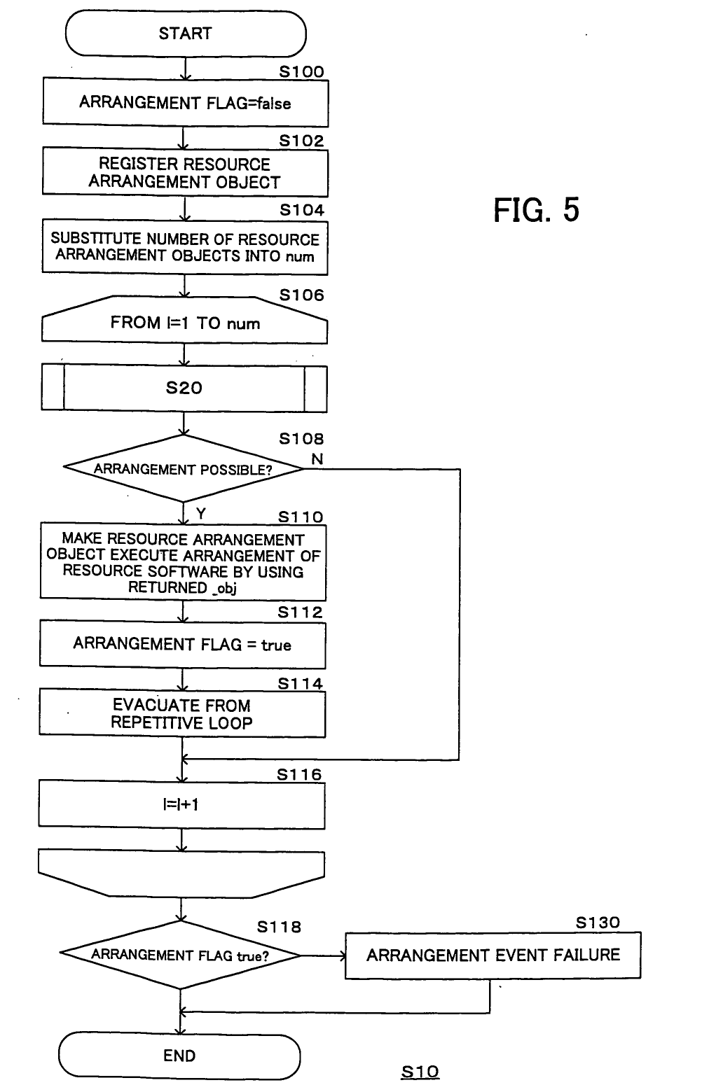

The processing of the resource management software 20 and the resource arrangement software 22 described above will be further described with reference to FIG. 5.

FIG. 5 is a flowchart showing the processing (S10) of the resource management software 20 and the resource arrangement software 22.

As shown in FIG. 5, the resource arrangement instructing part 204 of the resource management software 20 sets an arrangement flag to false as initialization in step 100 (S100).

In step 102 (S102), the registering part 220 of the resource arrangement software 22 registers its own information into the resource arrangement object storage part 202 of the resource management software 20.

Instep 104 (S104), the resource arrangement instructing part 204 of the resource management software 20 refers to the resource arrangement object storing part 202 to determine the number of the registered resource arrangement software 22 and substitutes the number into a variable num.

For example, when the resource arrangement software 22-1 to 22-n, num=n.

In step 106 (S106), the resource arrangement instructing part 204 starts the loop (repetitive) processing from a variable l=1 till num.

That is, when the resource arrangement software 22-1 to 22-n are registered, the determining part 222 of each of the resource arrangement software 22-1 to 22-n is successively executed.

The execution order may be predetermined like a registration order of the resource arrangement software 22 or the like.

In the following description, the resource arrange software 22-1 to 22-n are successively executed from the resource arrangement software 22-1 as a specific example.

In step 20 (S20), the resource arrangement instructing part 204 makes the determining part 222 of the resource arrangement software 22-1 execute to determine whether the resource software 24 should be arranged or not (described later with reference to FIG. 6).

In step 108 (S108), the resource arrangement instructing part 204 determines whether the reception result from the determining part 222 of the resource arrangement software 22-1 indicates that the arrangement is possible or not.

When the reception result from the determining part 222 of the resource arrangement software. 22-1 is the “arrangement-possible” result, the processing goes to step S110. In the other cases, the processing goes to step S116.

In step 110 (S110), the resource arrangement instructing part 204 makes the load part 224 of the resource arrangement software 22-1 execute the loading operation by using the object reference of the load part 224 of the resource arrangement software 22-1 which is received simultaneously with the “arrangement-possible” result.

The load part 224 of the resource arrangement software 22-1 loads the resource software 24 into the memory 152-1 of the board computer 10-1 and makes the resource software 24 execute its operation.

In step 112 (S112), the resource arrangement instructing part 204 sets the arrangement flag to true, and indicates that the arrangement of the resource software 24 has been completed.

In step 114 (S114), the resource arrangement instructing part 204 is evacuated from the loop processing because the arrangement of the resource software 24 has been completed, and goes to the processing of S120.

In step 116 (S116), the resource arrangement instructing part 204 increments 1 by “1” because the arrangement of the resource software 24 has not yet been completed, and goes to the processing of S106.

Instep 118 (S118), the resource arrangement instructing part 204 determines whether the arrangement flag is true or not.

When the arrangement flag is true, the processing is finished because the arrangement of the resource software 24 has been completed. In the other cases, the processing goes to step S130.

In step 130 (S130), the resource arrangement instructing part 204 makes an error output of arrangement event failure, etc. because the source software 24 is not arranged in any board computer 10.

FIG. 6 is a flowchart showing the processing (the processing of the method allocationJudge) (S20) of the determining part 222 shown in FIG. 5.

As a specific example of the processing of the method allocationJudge described below, it is determined on the basis of the environment (the following (1) to (7)) of the board computer 10 shown in FIG. 4A whether the resource software 24 can be arranged or not.

(1) Device Type: SH4

(2) OS type: Linux

(3) Storage Size: 300 MB

(4) Memory Size: 256 MB

(5) Number of Serial Ports: 2

(6) Speed of LAN interface: 100 MB

(7) Average Load of System: 3

As shown in FIG. 6, in the step 200 (S200), the method allocationJudge substitutes 0x00000000 into an Int type variable Path as initialization.

In step 202 (S202), the method allocationJudge reads a profile (FIG. 3B), and substitutes id, value of the profile into the variable Indivisual shown in FIG. 4B.

Furthermore, the method allocationJudge determines the length of the sequence of the variable Indivisual and substitutes determined length into a variable N.

Specifically, the length of the sequence of the variable Indivisual corresponds to the number of lines of the profile (in the case of FIG. 4B, the length of the sequence=N=6).

The variable N (the length of the sequence) is used as a loop frequency in the loop processing described below.

In step 204 (S204), the method allocationJudge starts the loop (repetitive) processing from the variable x=1 and continues to execute the loop processing until x is equal to N.

Specifically, the method allocationJudge takes out a pair of id and value stored at the first position of Indivisual for x=1, and executes the loop processing.

For x=2, the method allocationJudge takes out a pair of id and value stored in the second position of Indivisual, and executes the loop processing.

That is, for x=N, the allocationJudge takes out a pair of id and value stored in the N-th position of Individual and executes the loop processing.

The loop processing contains the following processing.

S30: The device type satisfies the condition (indispensable determination for determining whether the resource software 24 can operate or not; indispensable determination)

S32: The OS type satisfies the condition (indispensable determination)

S34: The storage size satisfies the condition (indispensable determination)

S36: The memory size satisfies the condition (indispensable determination)

S38: The number of serial ports satisfies the condition (determination recommended to determine whether the resource software 24 can operate or not; recommended determination)

S40: The communication speed of the LAN interface satisfies the condition (recommended determination)

S42: The average load of the system is equal to or less than a predetermined value (the system is under no-load state) (indispensable determination).

[Check of Device Type (S30]

In step 300 (S300), the method allocationJudge determines whether id==“device” or not.

When id==“device”, the method allocationJudge goes to the processing of S302. In the other cases, the method allocationJudge goes to the processing of S32.

That is, when id==“device”, the method allocationJudge goes to the processing of checking the device.

In step 302 (S302), the method allocationJudge substitutes the value of “value” into the string type variable str (type transformation).

For example, in the profile shown in FIG. 3B, value of id=“device” is “SH4”, and thus “SH4” is substituted into the variable str.

In step 304 (S304), the method allocationJudge determines whether str (the device type in which the resource software 24 can operate)==“SH4” (the device type of the board computer 10).

That is, the method allocationJudge determines whether the device type of the board computer 10 is equal to the device type in which the resource software 24 can operate.

When str==“SH4”, the method allocationJudge goes to the processing of S308, and in the other cases, the method allocationJudge goes to the processing of S306.

In step 306 (S306), the method allocationJudge substitutes false into a variable TorF1, and indicates that the device type is not a device type in which the resource software 24 can operate.

In step 308 (S308), the method allocationJudge substitutes the logical sum of Path and 0x00000001 into the variable Path, and indicates that the check (S30) of this device type is completed.

[Check (S32) of OS type]

In step 320 (S320), the method allocationJudge determines whether id==“OS”.

When id==“OS”, the method allocationJudge goes to the processing of S322, and in the other cases, the method allocationJudge goes to the processing of S34.

That is, when id==“OS”, the method allocationJudge goes to the processing of checking the OS type.

In step 322 (S322), the method allocationJudge substitutes the value of “value” into the string type variable str (type transformation).

For example, in the profile shown in FIG. 3B, value of id=“OS” is “Linux”, and thus “Linux” is substituted into the variable str.

In step 324 (S324), the method allocationJudge determines whether str (the OS type in which the resource software 24 can operate)==“Linux” (the OS type of the board computer 10).

That is, the method allocationJudge determines whether the type of OS installed in the board computer 10 is the type of OS in which the resource software 24 can operate.

When str==“Linux”, the method allocationJudge goes to the processing of S328, and in the other cases, the method allocationJudge goes to the processing of S326.

In step 326 (S326), the method allocationJudge substitutes false into the variable TorF2, and indicates that the OS type of the board computer 10 is not the type of OS in which the resource software 24 can operate.

In step 328 (S328), the method allocationJudge substitutes the value of the logical sum of Path and 0x00000010 into the variable Path, and indicates that the check of the OS type (S32) is completed.

[Check of Storage Size (S34)]

In step 340 (S340), the method allocationJudge determines whether id==“size” or not.

When id==“size”, the method allocationJudge goes to the processing of S342, and in the other cases the method allocationJudge goes to the processing of S36.

That is, when id==“size”, the method allocationJudge goes to the processing of checking the storage size.

In step 342 (S342), the method allocationJudge substitutes the value of “value” into the long type variable size (type transformation).

For example, in the profile shown in FIG. 3B, the value of id=“size” is “30000000”, and thus “30000000” is substituted into the variable size.

In step 344 (S344), the method allocationJudge obtains a consumption storage size which is consumed by the board computer 10 itself.

In step 346 (S346), the method allocationJudge adds the variable size with the consumption storage size which is consumed by the board computer 10 itself.

In step 348 (S348), the method allocationJudge determines whether 300 MB (the storage size of the board computer 10)=>size (the storage size at which the resource software 24 can operate+the consumption storage size which is consumed by the board computer 10 itself).

That is, it is determined whether [Storage size at which the resource software 24 can operate]+[the consumption storage size consumed by the board computer 10 itself] does not exceed [the storage size of the board computer 10].

For 300=>size, the method allocationJudge goes to the processing of S352, and in the other cases, the method allocationJudge goes to the processing of S350.

In step 350 (S350), the method allocationJudge substitutes false into the variable TorF3, and indicates that the storage size of the board computer 10 does not satisfy the storage size at which the resource software 24 can operate.

In step 352 (S352), the method allocationJudge substitutes the value of the logical sum of Path and 0x00000100 into the variable Path, and indicates that the check of the size of the storage (S34) is completed.

[Check of Memory Size (S36)]

In step 360 (S360), it is determined whether id==“memory”.

When id==“memory”, the method allocationJudge goes to the processing of S362, and in the other cases, the method allocationJudge goes to the processing of S38.

That is, when id==“memory”, the method allocationJudge goes to the processing of checking the memory size.

In step 362 (S362), the method allocationJudge substitutes value into the long type variable size (type transformation).

For example, in the profile shown in FIG. 3B, the value of id=“memory” is equal to “125000000”, and thus “125000000” is substituted into the variable size.

In step 364 (S364), the method allocationJudge determines whether 256 MB (the memory size of the board computer 10)=>size (the memory size at which the resource software 24 can operate).

That is, it is determined whether [memory size of the board computer 10] is not less than “memory size at which the resource software 24 can operate”.

When 256 MB=>size, the method allocationJudge goes to the processing of S368, and in the other cases the method allocationJudge goes to the processing of S366.

In step 366 (S366), the method allocationJudge substitutes false into the variable TorF4, and indicates that the memory size of the board computer 10 does not satisfy the memory size at which the resource software 24 can operate.

In step 368 (S368), the method allocationJudge substitutes the value of the logic sum of Path and 0x00001000 into the variable Path, and indicates that the check of the memory size (S36) is completed.

[Check of Number of Serial Ports (S38)]

In step 380 (S380), the method allocationJudge determines whether id==“serial”.

When id==“serial”, the method allocationJudge goes to the processing of S382, and in the other cases the method allocationJudge goes to the processing of S40.

That is, when id==“serial”, the method allocationJudge goes to the processing of checking the number of serial ports.

In step 382, the method allocationJudge substitutes “value” into the long type variable size (type transformation) For example, in the profile shown in FIG. 3B, the value of id=“serial” is equal to “1”, and thus “1” is substituted into the variable size.

In step 384 (S384), the method allocationJudge obtains the number of serial ports being used in the system.

In step 386 (S386), the method allocationJudge adds the variable size with the number of serial ports being used by the board computer 10.

IN step 388 (S388), the method allocationJudge determines whether 2 (the number of serial ports owned by the board computer 10)=>size (the number of ports required for the resource software 24 to operate+the number of serial ports being used by the board computer 10).

That is, it is determined whether [the number of ports required for the resource software 24 to operate]+[the number of serial ports being used by the board computer 10] does not exceed {the number of serial ports owned by the board computer 10}.

When 2=>size, the method allocationJudge goes to the processing of S206, and in the other cases, it goes to the processing of S390.

In step 390 (S390), the method allocationJudge substitutes false into the variable TorF5, and indicates that the number of serial ports owned by the board computer 10 does not satisfy the number of ports required for the resource software 24 to operate.

[Communication Speed Check (S40) of LAN Interface]

In step 400 (S400), it is determined whether id==“LAN”. When id==“LAN”, the method allocationJudge goes to the processing of S402, and in the other cases, the method allocationJudge goes to the processing of S42.

That is, when id==“LAN”, the method allocationJudge goes to the processing of checking the communication speed of the LAN interface.

In step 402 (S402), the method allocationJudge substitutes “value” into the long type variable size (type transformation).

For example, in the profile shown in FIG. 3B, the value of id=“LAN” is equal to “100”, and thus “100” is substituted into the variable size.

In step 404 (S404), the method allocationJudge determines whether 100 (the communication speed of the LAN interface of the board computer 10)=>size (the communication speed of the LAN interface at which the resource software 24 can operate).

That is, it is determined whether [the communication speed of the LAN interface of the board computer 10] is equal to or higher than [the communication speed of the LAN interface at which the resource software 24 can operate].

When 100=>size, the method allocationJudge goes to the processing of S406, and in the other cases the method allocationJudge goes to the processing of S206.

In step 406 (S406), the method allocationJudge substitutes false into the variable TorF6, and indicates that the communication speed of the LAN interface of the board computer 10 does not satisfy the communication speed of the LAN interface at which the resource software 24 can operate.

[Check of System Load (S42)]

In step 420 (S420), it is determined whether id==“load”. When id==“load”, the method allocationJudge goes to the processing of S422, and in the other cases the method allocationJudge goes to the processing of S206.

That is, when id==“load”, the method allocationJudge goes to the processing of checking the system load. In step 422 (S422), the method allocationJudge obtains the average load value of the board computer 10 (the load value of the system).

OS such as Linux, Window, etc. have the function of outputting the average load value of the system, and when the average load value thereof is not less than 4, it is generally determined that the load is high.

In step 424 (S424), the method allocationJudge determines whether 4 (a value at which the load is determined to be high)=>the average load value of the board computer 10.

As shown in FIG. 3C, when the average load value of the board computer 10 is equal to 3, this condition is satisfied.

When 4=>the average value, the method allocationJudge goes to the processing of S428, and in the other cases the method allocationJudge goes to the processing of S426.

In step 426 (S426), the method allocationJudge substitutes false into the variable TorF7, and indicates that the resource software 24 cannot operate because the system load of the board computer 10 is high. Instep 428 (S428), the method allocationJudge substitutes the value of the logic sum of Path and 0x00010000 into the variable Path, and indicates that the check of the system load (S42) is completed.

In step 206 (S206), the method allocationJudge increments the variable x by 1, and returns to the processing of the step S204 (S204). In step 208 (S208), the method allocationJudge determines whether no false exists in the values of the variables TorF1 to TorF7 and Path==0x00011111.

That is, [no false exists and Path==0x00011111] means that [check of all indispensable items is completed and the operation conditions of the resource software 24 are satisfied in all the checked items].

When no False exists in the values of the variables TorF1 to TorF7 and also Path==0x00011111, the method allocationJudge goes to the processing of S220, and in the other cases the method allocationJudge goes to the processing of S210.

In step 210 (S210), the method allocationJudge substitutes false into the variable TorF, and returns 0.

That is, the method allocationJudge notifies the resource arrangement instructing part 204 of the fact that the arrangement is impossible.

In step 220 (S220), the method allocationJudge sets the object reference of the load part 224 into the variable _obj.

In step 222 (S222), the method allocationJudge substitutes true into the variable TorF, and returns 1. That is, the method allocationJudge notifies the resource arrangement instructing part 204 of the fact that the arrangement is possible.

[Overall Operation]

The overall operation of the resource arrangement system 1 will be described.

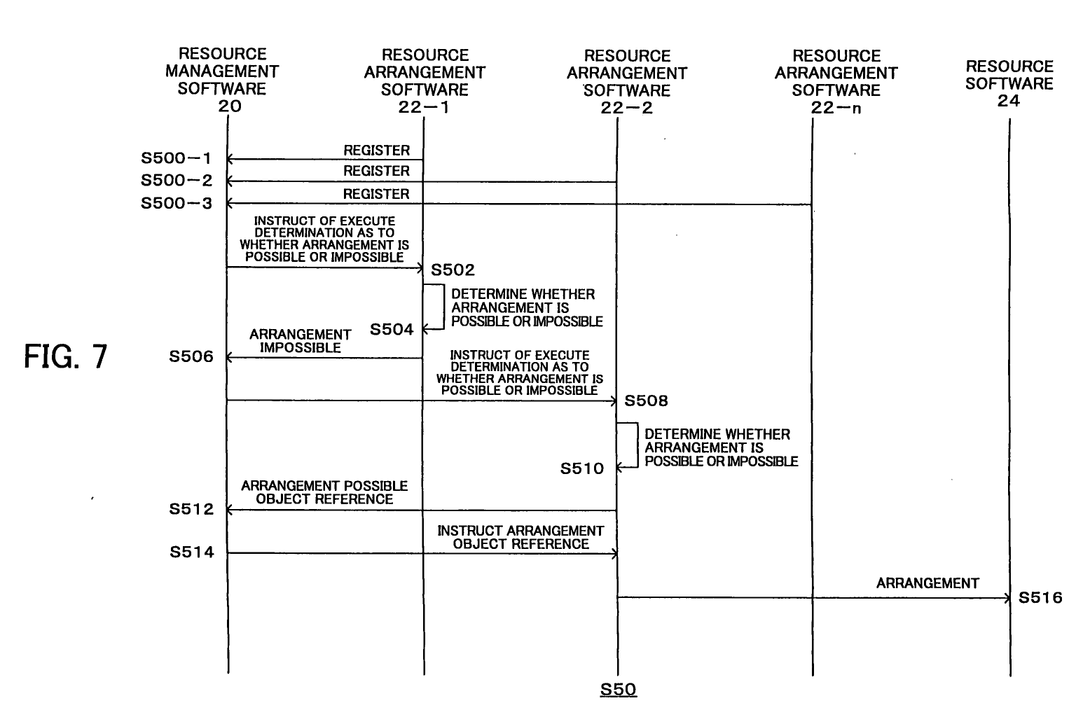

FIG. 7 is a communication sequence diagram (S50) showing the overall operation of the resource arrangement system 1.

In step 500 (S500), when the board computers 10-1 to 10-n (FIG. 2A) are connected to the Compact PCI 114, the resource arrangement software 22-1 to 22-n register their own object information into the resource management software 20.

In Step 502 (S502), the resource management software 20 makes the resource arrangement software 22-1 execute the arrangement-possible or arrangement-impossible determination of the resource software 24.

In step 504 (S504), by using the method allocationJudge, the determining part 222 of the resource arrangement software 22-1 determines whether the resource software 24 can be arranged in the board computer 10-1.

In step 506 (S506), the resource arrangement software 22-1 transmits the result of “arrangement impossible” to the resource management software 20.

In step 508 (S508), the resource management software 20 makes the resource arrangement software 22-2 executes the determination as to whether the resource arrangement software 24 can be arranged or not.

In step 510 (S510), the resource arrangement software 22-2 uses the method allocationJudge to determine whether the resource software 24 can be arranged in the board computer 10-2.

In step 512 (S512), the arrangement software 22-2 transmits the arrangement-possible result and the object reference of the load part 224 of the resource arrangement software 22-2 to the resource management software 20.

In step 514 (S514), the resource management software 20 makes the load part 224 of the resource arrangement software 22-2 load the resource software 24 on the basis of the received object reference.

In step 516 (S516), the resource arrangement software 22-2 loads the resource software 24 into the memory 152-2 of the board computer 10-2 and makes the resource software 24 execute the operation.

In the example of the overall operation described above, the case where the resource arrangement software 22-2 determines that the resource software 24 can be arranged is described as a specific example.

As described with reference to FIG. 5, the resource management software 20 makes the resource arrangement software 22-i (1≦i≦n) execute the “arrangement-possible” or “arrangement-impossible” determination until any one of the resource arrangement software 22-1 to 22-n determines the “arrangement-possible”.

What is claimed is:

1. A software radio device having plural executing devices constituting the software radio device as a whole, each of the executing devices executing application software by aboard computer, wherein first application software executed by at least one first executing device of the plural executing devices makes the first executing device execute an instructing step of instructing the executing device to execute a determination step, and upon reception of the instruction, second application software other than the first application software executed in the executing device makes the executing device execute the steps of determining, on the basis of an operation environment of predetermined application software and environmental information of the board computer whether the predetermined application software is executable in the executing device, and loading into the executing device the application software which is determined to be executable.

2. A computer system having plural executing devices each of which executes application software by a board computer, wherein first application software executed by at least one first executing device of the plural executing devices makes the first executing device execute an instructing step of instructing the executing device to execute a determination step, and upon reception of the instruction, second application software other than the first application software executed in the executing device makes the executing device execute the steps of determining, on the basis of an operation environment of predetermined application software and environmental information of the board computer whether the predetermined application software is executable in the executing device, and loading into the executing device the application software which is determined to be executable.

3. A software radio device having plural executing devices constituting the software radio device as a whole, each of which executes application software on the same operating system as or different operating system from another executing device,
wherein first application software executed by at least one first executing device of the plural executing devices makes the first executing device execute an instructing step of instructing the executing device to execute a determination step, and upon reception of an instruction, second application software other than the first application software executed in the executing device makes the executing device execute the steps of determining on the basis of predetermined application software, the executing device and the attribute of the OS of the executing device whether the predetermined application software is executable in the executing device, and loading into the executing device the application software which is determined to be executable.

4. The software radio device according to claim 1, wherein each of the operation environment of the predetermined application software and the environmental information of the board computer is at least one of the type of the device, the type of OS, storage size, memory size, the number of ports, an interface speed or a system load.

5. The computer system according to claim 2, wherein each of the operation environment of the predetermined application software and the environmental information of the board computer is at least one of the type of the device, the type of OS, storage size, memory size, the number of ports, an interface speed or a system load.

6. The software radio device according to claim 1, wherein the first application software makes the first executing device execute the instructing step until any of the second application software executed in the plural executing devices determines that the predetermined application software is executable in the executing device.

7. The computer system according to claim 2, wherein the first application software makes the first executing device execute the instructing step until any of the second application software executed in the plural executing devices determines that the predetermined application software is executable in the executing device.
